(19) United States
(12) Patent Application Publication
(10) Pub. No.: US 2009/0060324 A1
(43) Pub. Date: Mar. 5, 2009

(54) IMAGE ENHANCEMENT AND COMPRESSION

(76) Inventor: Massino Ballerini, Milano (IT)

Correspondence Address: FISH & RICHARDSON, PC, P.O. BOX 1022, MINNEAPOLIS, MN, 55440-1022, US

(21) Appl. No.: 12/067,039

(22) PCT Filed: Sep. 14, 2006
(86) PCT No.: PCT/IB2006/003012

§ 371 Date: Jun. 25, 2008

Related U.S. Application Data
(60) Provisional application No. 60/717,585, filed on Sep. 14, 2005.

(51) Int. Cl. G06K 9/00

(52) U.S. Cl. 382/166

(57) ABSTRACT

A digital image is compressed by determining a composite color number for each pixel in a digital image represented by a plurality of pixels in a first color space. A first set of color values are extracted from the determined composite color numbers. The first set of color image values are then compacted into a second set of color values according to a predetermined encoding algorithm. A quantity of color values in the second set of color values is smaller than a quantity of color values in the first set of color values. A modified image based on the second set of color values is then generated. A transformation algorithm is then applied to the modified image.

### CROSS-REFERENCE TO RELATED APPLICATIONS

This application claims the benefit of the filing date of U.S. Provisional Application No. 60/717,585, filed Sep. 14, 2005, the entire contents of which are incorporated by reference as part of this application.

### BACKGROUND

The subject matter described herein relates to methods of enhancing and compressing digital images and a system incorporating such methods.

A digital image may be a color or a black and white image represented by a finite set of digital values, called picture elements or pixels. Digital images may represent still images, or pictures, as well as video images, which are sequences of still images displayed in a manner that depicts motion. Image compression is the application of data compression on digital images. In effect, the objective is to remove redundancy or imperceptible features of the image data in order to be able to store or transmit data in an efficient form. Image enhancement, on the other hand, is the manipulation of image characteristics such as tonality, luminosity, clarity, contrast, depth, saturation, and texture contained in the information of color. One typical goal of image enhancement is to render digital images to resemble as close as possible to images seen in nature.

Color can be completely specified by just three parameters. Their meanings depend on the particular color model used. A number of color models have been developed that attempt to represent a gamut of colors, based on a set of primary colors, in a three-dimensional space. Each point in that space depicts a particular composite color made up of the primary colors. One traditional model is the RGB (Red, Green, Blue) color model. The RGB color model is an additive model in which red, green, and blue primary colors are combined in various ways to create other composite colors.

FIG. 1 illustrates a traditional RGB color model 100. The RGB color model 100 has each dimension of the cube representing a primary color and is mapped to a cube 102 with Cartesian coordinates (R,G,B) 104. Similarly, each point within the cube identified by a triplet (R,G,B) represents a particular composite color where the individual components R, G, or B shows the contribution of each primary color towards the given composite color. The diagonal of the cube 106 (where the three RGB components are equal) represents the grayscale with black being 0% of the length of the diagonal and white being 100%.

The RGB model 100 is popular in computer graphics. The amount of available composite colors depends on the number of bits used for each primary color component. Typical modem day computer displays use a total of 24 bits of information for each pixel, a format referred to as “24-bit true color.” This corresponds to 8 bits each for red, green, and blue, giving a range of 256 possible tones or color values for each primary color. With the 24-bit true color scheme, approximately 16.7 million discrete colors can be reproduced, even though human vision can distinguish only among about 10 million discrete colors. The human visual response varies from person to person depending upon the condition of eye and the age of person.

The printing industry, on the other hand, normally uses a CMYK color model. The CMYK model is a subtractive color model that is based on mixing the following color pigments: Cyan (C), Magenta (M), Yellow (Y), and Black (K). The mixture of ideal CMY colors is subtractive, i.e., cyan, magenta, and yellow printed together on a white paper result in black. However, a mixture of practical cyan, magenta, and yellow pigments is not pure black, but a dark murky color. Thus, a black ink is used in addition to CMY colors in printing to produce a more intense, purer black color.

Conventional image compression techniques are generally referred to as being either “lossless” or “lossy”, depending upon whether data is discarded in the compression process. Examples of conventional lossless compression techniques include Huffman encoding, arithmetic encoding, and Fano-Shannon encoding. With a lossless compression, the decompression process will reproduce the entire original image. Lossless compression is important for images found in such applications as medical and space science. In such situations, the designer of the compression algorithm must be very careful to avoid discarding any information that may be required or even useful at some later point when a compressed image is to be decompressed.

Lossy compression, in contrast, provides greater efficiency over lossless compression in terms of speed and storage, as some data is discarded. As a result, lossy techniques are employed where some degree of inaccuracy relative to the input data is tolerable. Accordingly, lossy compression is frequently used in video or commercial image processing. Two popular lossy image compression standards are the MPEG (Motion Picture Experts Group) and JPEG (Joint Photographic Experts Group) compression methods.

In addition to imaging systems, compression technology can be incorporated into video servers for “video on demand” applications. Compression technology can also be applied to streaming video, for example, the real-time capture and display of video images over a communications link. Applications for streaming video include video telephones, remote security systems, and other types of monitoring systems.

Digital image compression invariably deals with large quantities of data, and one way to achieve compression of images is to ignore some of the data. The data ignored must be done selectively and the guiding principle is to discard data for which the human visual system is not sensitive. Essentially, image compression mathematically transforms a grid of image pixels into a new, much smaller set of digital values holding the information needed to reconstruct the original image or data file. With the advent of multi-megapixel digital cameras/camcorders and the ubiquity of camera phones, there is a tremendous need to store, transfer, and view digital images. The enormous size of these digital image files leads to serious file management limitations. For example, a single still image (equivalent to a single frame of video) displayed by a conventional array of 640×480 pixels, with the color of each pixel represented by 24 bits, would require approximately 1 megabytes of digital memory to store.

### SUMMARY

This specification describes technology relating to image enhancement and compression.

The present inventor recognized that in the traditional RGB color model 100, only the tonal axes 104 of primary colors are determined and the ability to represent the grayscale 106 appears only when the three colors have the same value. Furthermore, the present inventor recognized that, in the RGB model 100, any composite color may be generated from the component of gray. In other words, the gray component contains information pertaining to the tonal relationship of color and the gradual scale of white in a composite color.

Consequently, the present inventor developed a method of efficiently managing and transmitting the information of color representing high quality images. The image enhancement algorithms in this disclosure address deficiencies of the existing RGB model 100 by introducing a virtual gradual axis representing the amount of white or luminance into the composite colors and allow for an easy relationship between color and luminance when the primary colors are not of the same value. The image enhancement algorithm allows the intensity of light, or luminance, to be incorporated into the component color values, thereby allowing for a constant color-luminance relationship. Once the component color values are extracted, many different geometrical models, for example square (quadratic), cubic, or circular models, can be used to incorporate a virtual luminance axis into the traditional tonal axis and achieve a two-dimensional representation of the color values.

Additionally, the present inventor developed a simple and efficient image compaction-compression method to achieve a substantially reduced file size for a compressed image while maintaining a visually lossless decompressed digital image. The digital compaction-compression algorithm enables a digital image to be compressed by reducing or compacting the color values of each component color without substantial loss of the image quality. The image compaction-compression algorithm may be used to provide transmission and display of video images using the compressed “dark” images. Since the file sizes for the dark images are substantially smaller than the original file sizes, efficient, real-time streaming video or video-on-demand systems may be achieved.

One aspect of this disclosure is to create enhanced digital images by manipulating or calibrating tonality, luminosity, clarity, contrast, depth, saturation, and plasticity contained in the information of color. The perceived quality of these enhanced images will therefore be as close as possible to the true color and vibrancy of nature. Keeping in mind that the judge of quality in these enhanced images is the subjective human visual system, the development for enhanced images in this disclosure is directed with a universal approach capable of achieving a “correct”, or “true” emotion evoked by vision from any image created. Another aspect of this disclosure is to achieve a method of creating the high-quality still image or motion picture appearing in all media, while having these images be smaller in size than their counterparts created without the algorithms of the present disclosure.

In another aspect, a digital image is compressed by determining a composite color number for each pixel in a digital image represented by a plurality of pixels in a first color space. A first set of color values are extracted from the determined composite color numbers. The first set of color values are then compacted into a second set of color values according to a predetermined encoding algorithm. A quantity of color values in the second set of color values is smaller than a quantity of color values in the first set of color values. A modified image based on the second set of color values is then generated. A transformation algorithm is then applied to the modified image.

In another aspect, a compressed digital image is transferred by determining a composite color number for each pixel in a digital image represented by a plurality of pixels in a first color space. A first set of color values are extracted from the determined composite color numbers. The first set of color values are then compacted into a second set of color values according to a predetermined encoding algorithm. A quantity of color values in the second set of color values is smaller than a quantity of color values in the first set of color values. A modified image based on the second set of color values is then generated. A transformation algorithm is then applied to the modified image. An optional back-end compression coding (for example, Huffman coding) may be further applied to the transformed image. The transformed image is then transmitted by a first communications device. The transformed image is then received by a second communications device. After receiving the transformed image, the second set of color values are then decoded into a third set of color values according to a predetermined decoding algorithm. The third set of color values are substantially similar to the first set of color values. Finally, the digital image is reconstructed using the third set of color values.

In a further aspect, a digital image is enhanced by determining a composite color number for each pixel in a digital image represented by a plurality of pixels in a first color space. A first set of color values are extracted from the determined composite color numbers. The first set of color values are then compacted into a second set of color values according to a predetermined enhancement algorithm. A quantity of color values in the second set of color values is smaller than a quantity of color values in the first set of color values. An enhanced image based on the second set of color values is then generated.

Implementations may include one or more of the following features. The original digital image may be one of a BMP format, JPEG format, TIFF format, and a GIF format. The digital image may be one of (CMY), (L*a*b), (YCC), (L*u*v), (Yxy), (HSV), (CMYK), (MCYK), and (RGBW) color spaces. The digital image may be a color or a black- and-white image. The digital image may also be still or video images. The first and second set of color values may be selected from a group of integers between 1 and 255. The transformation algorithm may include translating the modified image into a second color space and converting the image in the second color space into a frequency space. For example, the second color space may be a YCrCb color space and the conversion process may be a forward discrete cosine transform (FDCT) process.

In one variation, the predetermined encoding algorithm may be represented by CV_{reduced}={[(CV_{original}* √2)*(CV_{original}/255)]+√(255*√2/√3)}/(2π); where CV_{reduced} represents the second set of color values and CV_{original} represents the first set of color values. In another variation, the predetermined encoding algorithm may be represented by CV_{reduced}=CV_{original}* k; where k is a constant between about 0.01 to 1, and where CV_{reduced} represents the second set of color values and CV_{original} represents the first set of color values.

In one variation, the predetermined decoding algorithm may be represented by CV_{decode}=CV_{reduced}*2π, where CV_{reduced} represents the second set of color values and CV_{original} represents the first set of color values. In another variation, the predetermined decoding algorithm may be represented by CV_{decode}=CV_{reduced}/k, where k is a constant between about 0.01 to 1, and CV_{reduced} represents the second set of color values and CV_{original} represents the first set of color values.

In one variation, the predetermined image enhancement algorithm may be a quadratic relationship represented by CV_{enhanced}=(CV_{original}*CV_{original}/255), where CV_{enhanced} represents the second set of color values and CV_{original} represents the first set of color values.
In another variation, the predetermined image enhancement algorithm may be a circular relationship represented by CV_{enhanced}=(CV_{original}*2π), where CV_{enhanced} represents the second set of color values and CV_{original} represents the first set of color values. In a further variation, the predetermined enhancement algorithm may result in a one-button action for achieving: contrast adjustment, color adjustment, light inversion, parametric adjustment, and brightness adjustment.

Computer program products, which may be embodied on computer readable-material, are also described. Such computer program products may include executable instructions that cause a computer system to conduct one or more of the method acts described herein. Similarly, computer systems are also described that may include one or more processors and a memory coupled to the one or more processors. The memory may encode one or more programs that cause the one or more processors to perform one or more of the method acts described herein.

These general and specific aspects may be implemented using a system, a method, or a computer program, or any combination of systems, methods, and computer programs.

The subject matter described herein may provide one or more of the following advantages. For example, the image enhancement algorithm in one implementation is a model of digital quantization of pure RGB color in any single pixel to achieve a higher level of quality of image treatment and true vision. The flexibility of the image enhancement algorithm has several advantages over existing algorithms by providing: a much more efficient control of luminosity; a very sophisticated and qualitative control of the color filters (not see-through but generated from within the original relationship of the three colors); a better control of the contrast; a better color balancing (purification of the hidden dominants); an improved enhancement of colors; a black and white which are more contrasting compared to the normal scale of grays (real symbolic function of the light and the dark); and the inversion of the light without the opposite inversion of colors, which offers advantages in various applications.

The proposed algorithm allows for semi-automatic touch-ups of the digital image by working within the specific color parameters in the luminance area; rather than an intervention on the entire image. The core image treatment features of the exemplary implementations are easy to use and typically involve only automatic, one-button controls. Instead of the existing methods of focusing on the number of unique colors present in the digital image, present implementations focus on the identification and manipulation of the significant color pixels contained in the image. Additionally, when adjusting for light and brightness, existing algorithm merely overlays a white color on top of the digital image while present implementations add light inside the colors. Rather than working with pixel blocks, image compression implementations work on the specific color in a specific luminance area based on individual pixels. Even when the color values in a digital image are substantially reduced, there is no loss of quality when perceived by the human eye because the relationship between the basic luminance area of the object has not been changed.

Other aspects, features, and advantages will become apparent from the following detailed description, the drawings, and the claims.

### DRAWING DESCRIPTIONS

FIG. 1 illustrates the traditional RGB color model using a cubic representation.

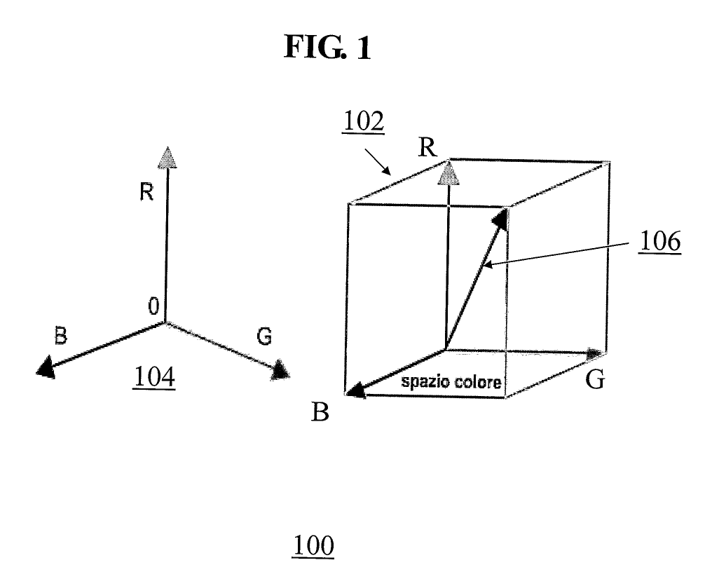

FIG. 2 illustrates a tetrahedral method utilized in the image enhancement and compression algorithms.

FIGS. 3A-C depict various representations of a quadratic method utilized in the image enhancement and compression algorithms.

FIG. 4 depicts a circular method utilized in the image enhancement and compression algorithms.

FIG. 5 shows a process flowchart of one implementation of the image enhancement algorithm.

FIG. 6 shows a process flowchart of one implementation of the image compression algorithm.

Like reference symbols in the various drawings indicate like elements.

### DETAILED DESCRIPTION

The subject matter described herein relates to methods of enhancing and compressing digital images and a system incorporating such methods.

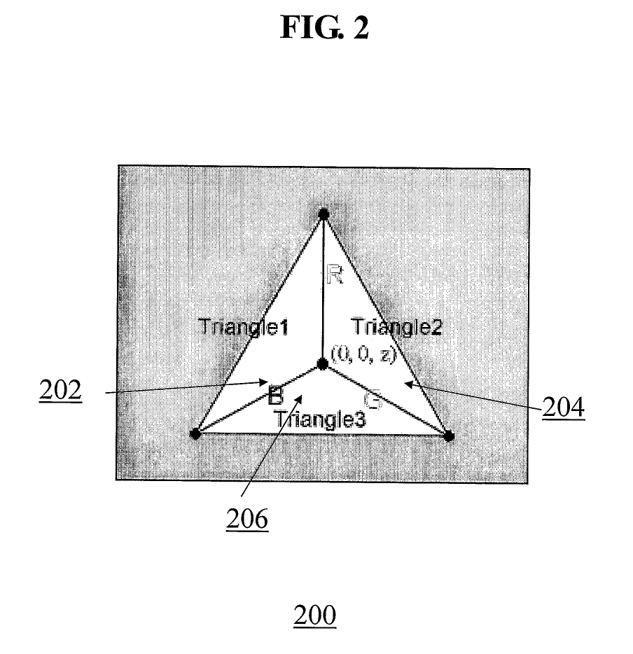

FIG. 2 illustrates a tetrahedral color model 200 used in the image compression and enhancement algorithms. This tetrahedral model 200 produces a surface derived from the sum of the triangles (Triangle1 202+Triangle2 204+Triangle3 206), which represents a composite color space, with a corresponding saturation component of the composite color.

The tetrahedral representation 200 allows seven changes in the color values while maintaining the fundamental relationships that exist between the three primary colors. The seven color variables are: pure value of red (R), pure value of green (G), pure value of blue (B), the value of Triangle1 202=((R*B)/2), the value of Triangle2 204=((R*G)/2), the value of Triangle3 206=((B*G)/2), and the value of the sum of Triangle1+Triangle2+Triangle3. Furthermore, the seven color values can be extracted from the tetrahedral model 200 as follows:

Primary Colors=R, G, and B

Complimentary=(R*G)/2−B=Yellow

More single color=(R*G)/2+B=Blue

Complimentary=(G*B)/2−R=Cyan

More single color=(G*B)/2+R=Red

Complimentary=(R*B)/2−G=Magenta

More single color=(R*B)/2+G=Green

Surface composite color=((R*G)/2)+((G*B)/2)+((R*B)/2)

The expansion or reduction of the surface composite color completely modifies the luminosity of the image, yet always in a perfect relation to the tonality of the composition of the original triplet of colors.

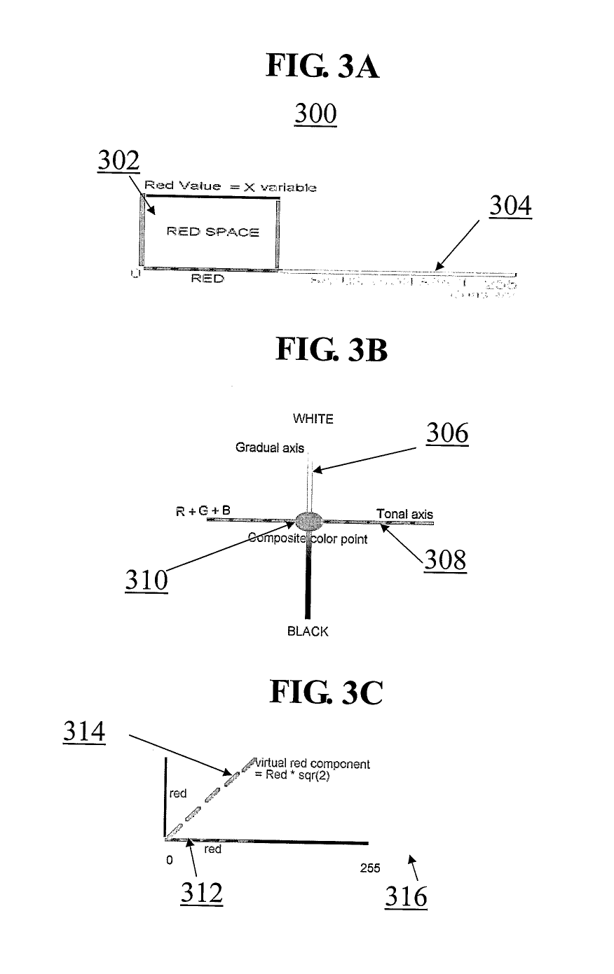

FIG. 3A depicts a quadratic model 300 used in the image enhancement and compression algorithms. The quadratic model 300 is a representation of the tonal-luminance relationship which includes a specific relationship between the squared color component 302 and its color saturation limit 304. Human vision is designed for an optimal color and luminance relationship. Luminance is a quantity that is closely related to the intensity or brightness of a light source as perceived by the eye. Human eyes are more sensitive to changes in luminance than color because the human retina contains more rods than cones. Whereas the cones are capable of only distinguishing approximately 10 million discrete colors, these rods are extremely sensitive to light and dark and can respond to even a single photon of light. When an image is displayed on a color monitor, the color is not optimized with respect to luminance because the traditional RGB model 100 does not incorporate luminance. For example, inside the RGB color cube 100, the intensity of light is represent by the diagonal 106 of the cube containing 256 different gray values from the origin (0,0,0), which is black, to (1, 1, 1), (2, 2, 2), (3, 3, 3,), . . . up to (255,255,255), which is white.

Since human eyes are more sensitive to luminance than color, the quadratic model 300 enhances the digital image by incorporating the luminance value into the component colors with a virtual luminance representation, as shown in FIG. 3B. Similar to the use of CMYK colors in the printing world, where black color (K) is added to give a better “intensity” of truer black, here a luminance component 306 is added to the RGB tonal axis 308. The incorporation of virtual luminance axis 306 creates a composite color point 310 that is a two-dimensional representation of color and allows for independent adjustment of chrominance and luminance without over-saturating the color image.

Currently in the exiting algorithms with only tonal analysis, one can only increase or decrease the tone or value of the color in a fixed relationship to luminance. That is because the white point is fixed at a color value of 255 for each of the RGB color component to arrive at (255,255,255). The quadratic model 300 can increase the “intensity” of any component color value by applying a variable relationship with the value of luminance (white) based on a constant scaling factor (i.e., R_{original}/255) rather than a fixed point (i.e., 255). This color-luminance relationship is closer therefore to the printing world of using black in the CMYK method. This quadratic model 300 also offers better contrast, luminance, and color that results in sharper and clearer images. The quadratic model 300 essentially takes a standard tonal only image, applies the virtual luminance axis 306, and after processing the image, saves again a tonal-incorporating-luminance image with a much better quality.

FIG. 3C depicts the new saturation limit of the quadratic model 300. The quadratic relationship generates a strong increment of contrast, as well as demands a more sophisticated control. In this case it becomes necessary to extract from the space 312 of a single color created with its own squared (color value*color value) which is the value of the diagonal 314 represented in that space; i.e., Diagonal =color value *√2. Consequently the relationship between the squared of the distinctive color value and its saturation limit 316 will change from 255 (the maximum in 8-bit channel color representation=255) to the new value, New Saturation Limit=(255)*√2=360. Therefore, using a quadratic relationship, the factor of √2 relates the original component color value based only on the tonal axis to a virtual component color value based on both tonal and luminance axes. This factor will change depending on the relationship chosen; for example, in a cubic relationship, a factor of √3 will be used.

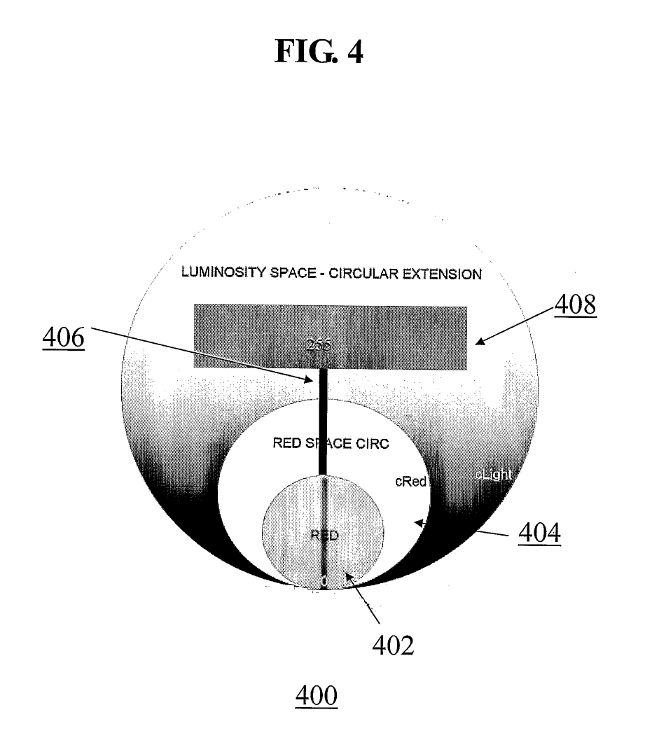

FIG. 4. illustrates a circular method 400 used in the image enhancement and compression algorithms. The circular method uses a circle for a two-dimensional representation of tonal and luminance axes. The circular model 400 includes a specific relationship between the circle produced by the color value (R, G, B) and the circle produced by its corresponding saturation limit (Rₘₐₓ, Gₘₐₓ, Bₘₐₓ).

Referring to FIG. 4, Red 402 represents the color value of the Red component, which indicates the value of Red tonality with respect to original saturation limit of 255 (Red/White). This Red 402 becomes the radius of a new Red Space Circle (RSC) 404. The circumference of the RSC 404 is then represented by cRed=(radius*2π) or (Red/0.159). This variable, cRed (depends on what value Red has), accurately defines the RSC 404.

Since RSC 404 is the new representation of the original Red color component in the circular model 400, the original saturation limit 406 (White) will also change correspondingly. This new saturation limit is represented by Light (luminosity) circumference, clight 408, where cLight=255/0.159, in order to maintain the constant relationship between Red 402 component and its saturation limit. Using the traditional RGB model 100, Red component is variable and the saturation limit (White) is fixed at 255. In contrast, with the circular method 400 having the Red Space Circle 404 relate to the Light Circle 408, one may determine automatically or manually color or light and the relationship between them. Additionally, traditionally if Light is increased the image is overexposed because the decrease in color component clouds the color. This does not happen with the circular method 400 because either color or Light can be adjusted independently with respect to each other.

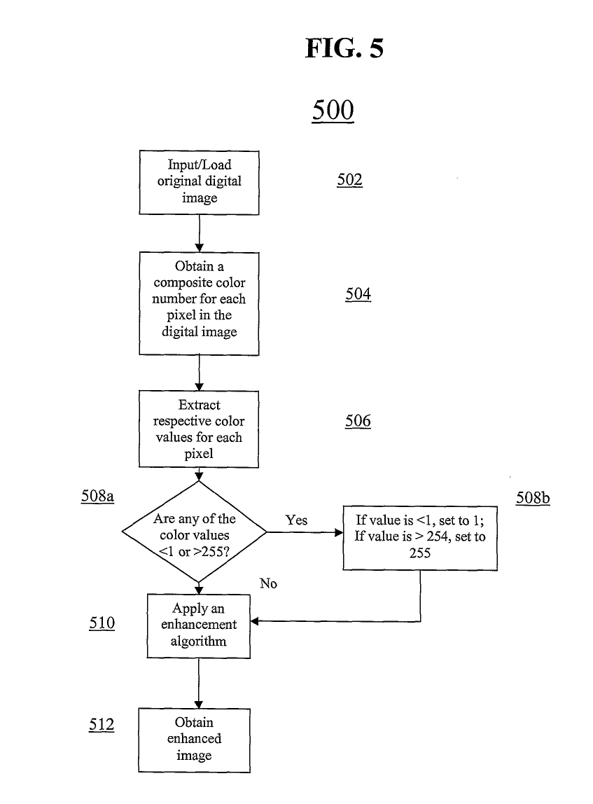

FIG. 5 shows a flowchart process 500 of one implementation of the image enhancement algorithm. Process 500 illustrates one implementation of the image enhancement algorithm using a digital color image represented in an RGB color format. However, the original image may be represented by any standard color space; for example it may be any one of (CMY), (L*a*b), (YCC), (L*u*v), (Yxy), (HSV), (CMYK), (MCYK), and (RGBW) color spaces. The digital image may be a color or a black-and-white image. The digital image may also be still or video images. At step 502, process 500 receives as input a digital color image. At step 504, process 500 obtains the composite color number for each pixel in the digital image. For example, based on a 24-bit color scheme, a composite color number of 0 will correspond to black and a composite color number of 16,777,215 will correspond to white; while having a color gamut of roughly 16.7 million unique colors in between. Next, step 506 extracts the original RGB component color values, (R,G,B), for each pixel in the digital image based on the composite color numbers. Depending on the composite color number, the color value for each component of R, G, and B will vary from 0 to 255. Steps 508a and 508b then filter the extracted RGB color values to make sure that the component color values are limited to integer values between 1 and 255. This filtering function is required when there are floating point calculations involved in order to limit the color values to the values of the RGB color space.

Following the filtering step 508, step 510 applies an image enhancement algorithm to enhance the digital image. This specific algorithm may incorporate the tetrahedral model 200, the quadratic model 300, or the circular model 400. The enhancement algorithm may be use to achieve brightness, contrast, color enhancer, color purifier, auto-balance, black-and-white contrast, light inversion, parametric filters for changing luminance zones of images within specific color, or any other desired image enhancement operations.

Once the appropriate algorithm or sequence of algorithms have been applied to enhance the original digital image, step 512 obtains new RGB color values for the enhanced digital image. This enhanced digital image may then be displayed on a monitor or any device capable of rendering the enhanced image. Furthermore, this enhanced digital image may be saved unto a storage device such a hard drive, a flash drive, or a removable memory.

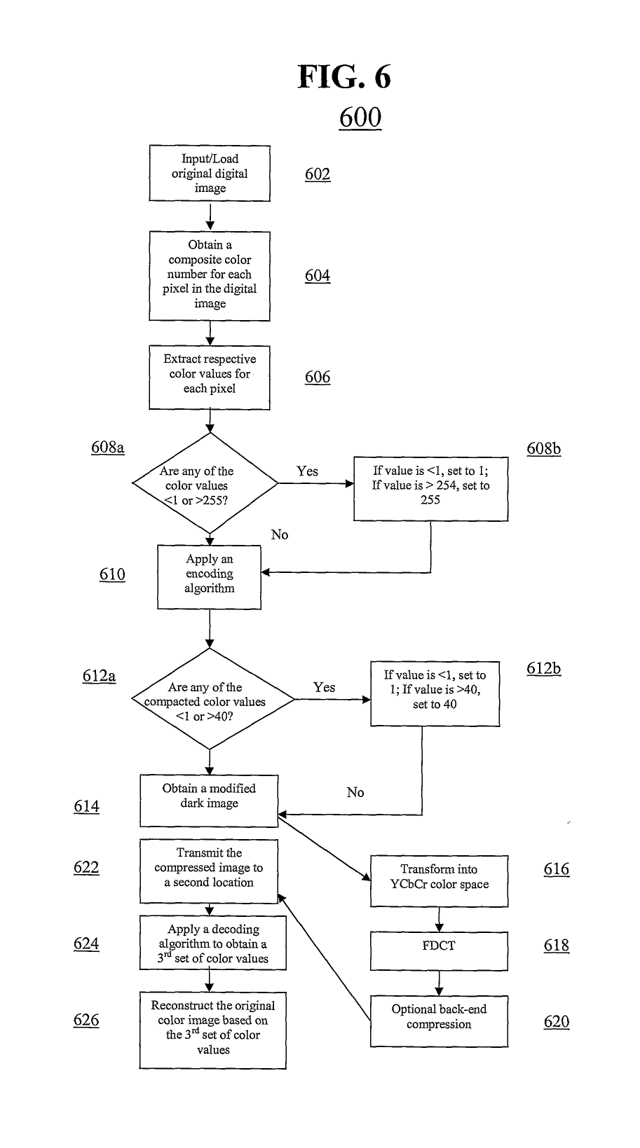

FIG. 6 shows a flowchart process 600 of one implementation of the image compression algorithm. Process 600 illustrates one implementation of the image compression algorithm using a digital color image represented in an RGB color format. However, the original image may be represented by any standard color space; for example, it may be any one of (CMY), (L*a*b), (YCC), (L*u*v), (Yxy), (HSV), (CMYK), (MCYK), and (RGBW) color spaces. The digital image may be a color or a black-and-white image. The digital image may also be still or video images. At step 602, process 600 receives as input a digital color image with the pixel color represented by a specified number of bits. Step 604 then obtains the composite color number for each pixel in the digital image. For example, based on a 24-bit color scheme, a composite color number of 0 will correspond to black and a composite color number of 16,777,215 will correspond to white; while having a color gamut of roughly 16.7 million unique colors in between. Next, step 606 extracts the original RGB component color values, (R,G,B), for each pixel in the digital image based on the composite color numbers. Depending on the composite color number, the color value for each component of R, G, and B will vary from 0 to 255. Steps 608a and 608b then filter the extracted RGB color values to make sure that the component color values are limited to integer values between 1 and 255. This filtering function is required when there are floating point calculations involved in order to limit the color values to the values of the RGB color space.

Following the extraction of the RGB color values for each pixel in the digital image, step 610 applies an encoding algorithm to “compact” the original RGB component color values into “reduced” color values. This encoding algorithm is applied to every RGB component color value; for example, in one implementation, the reduced color value for R component, R_{reduced}, is obtained with the following mathematical formula:

R_{reduced}={[(R_{original}*√2)*(R_{original}/255)]+√(255*√2/√3)}/(2π); (1)

where R_{original} is the original color value for R extracted by step 606 and filtered by step 608. In another implementation, the component color value may be compacted using a constant reducer according to the following mathematical formula:

R_{reduced}=R_{original}*k; (2)

where k is a constant number between about 0.01 to 1.

The encoding algorithm expressed in Equation 1 produces the reduced color values by first enhancing the quality of the digital image before compressing the original color values. The first term in Equation 1 is a quadratic optimizer which uses the quadratic model to represent a component color value that incorporates luminance. Using a quadratic relationship, the factor of √2 in Equation 1 relates the original component color value based only on the tonal axis to a virtual component color value based on both tonal and luminance axes. This factor will change depending on the relationship chosen; for example, in a cubic relationship, a factor of √3 will be used. The second term in Equation 1 takes into account that the luminance is spread over all three color components; therefore, the amount of luminance per color components is extracted here. Thus, this allows for a different presence of white inside each of the component colors by preventing overexposure of the enhanced digital image.

As mentioned above, the encoding algorithm utilizes a quadratic optimizer to first enhance the images by incorporating luminance inside each of the component colors. Additionally, the encoding algorithm transforms the enhanced color values into reduced color values based on a chosen transform method. For example, Equation 1 describes a circular method 400 by which a circle is used for a two-dimensional representation of tonal and luminance axes, as shown in FIG. 4. The original component color value of 1 to 255 is mapped on to the circumference of a circle to generate a virtual component space circle.

Since only the radius of a circle is needed to fully characterize this component space circle. A “reduced” color value using the radius of this component space circle sufficiently contains all the information of the original component color values. Image compaction is thus achieved by using a smaller number (reduced number) of color values to describe a component color. There is a fixed relationship (e.g., for circular method, circumference=radius*2π) between the original component color value and its radius. By equating the circumference to the range of available color values (1 to 255), the original component color value can be mapped to a reduced color value represented by the radius of the component space circle. Thus, the original color value is reduced because of the relationship: radius=circumference/2π. For example, using a circular method, the 255 available colors will be reduced down to approximately 40 colors using the scaling factor of 1/2π or 0.159. Since human vision is extremely sensitive to intensity of light but can only distinguish roughly 10 million discrete colors, the encoding algorithm using a combination of quadratic optimizer and circular transform method effectively achieves a compression of digital images with substantially lossless quality with respect to the human visual system.

After the encoding step 610, the reduced component color values are filtered in steps 612a and 612b, similar to the filtering function of steps 608a and 608b, to make sure that the reduced component color values are limited to integer values between 1 and 40, in the case of a circular method. Another implementation of the encoding algorithms may utilize the diameter-circumference relationship of the circular model 400 to represent the tonal-luminance axes. In which case, the reduced component color values would be between 1 and 80 for each color component. Step 614 then assembles the reduced component color values for each pixel into a modified “dark” image. This image appears “dark” because the reduced component color values have been compacted and contain less color gamut than the original 256 color values. Additionally, because of the reduced value for the component colors, from 255 down to 40, the file size for the modified “dark” image becomes smaller than the original file size.

After the original image is compacted into a modified “dark” image using a tetrahedral, a quadratic, a circular method, or any combination thereof, the “dark” image may be transformed using a transformation algorithm. For example, in step 616 the “dark” image is converted from RGB to a different color space called YCbCr. In the YCbCr color space, the Y component represents the luminance; Cb and Cr components together represent chrominance. Next, each component (Y, Cb, Cr) of the transformed “dark” image is “tiled” into blocks of 8×8 (or up to 32×32) pixels each, then each tile is converted to frequency space using a two-dimensional forward discrete cosine transform (FDCT) in step 618. Unlike JPEG compression algorithm which uses a quantization table to reduce values in the frequency domain, no quantization table is needed for the compaction-compression algorithm because the modified “dark” image already has reduced color values. Furthermore, an optional “back-end” lossless compression (for example, Huffman coding) may be implemented in step 620 to further compress the image.

Step 622 then transfers the compressed image obtained in either step 618 (without back-end compression) or step 620 (with back-end compression) to a second location. This second location may be a memory device such as a hard drive, a flash drive, or a removable memory. The second location may be a remote device linked through a communications network such as the Internet or a Wireless LAN.

Once the compressed image is transferred to the second location, step 624 then applies a decoding algorithm to obtain a set of decoded component color values. The decoding algorithm essentially performs inverse transforms of the compaction-compression algorithm. First, the compressed image will be decompressed using an inverse DCT. Next, the component color values are extracted so that an inverse “compaction” process can be performed. The inverse compaction may use any algorithm capable of decoding the encoded color values of step 610. For example, in the implementation using Equation 1 as the encoding algorithm, the decoding algorithm uses the following formula:

R_{decode}=R_{reduced}*2π; (3)

where R_{decode} is the decoded component color value for R and R_{reduced} is the reduced component color value obtained from Equation 1. On the other hand, if Equation 2 is used for the encoding algorithm, then the decoding algorithm uses the following simple formula:

R_{decode}=R_{reduced}/k; (4)

where k is once again a constant number between about 0.01 and 1. Since the k value is stored in the image header during the encoding process (in the case of constant reducer), the same k value is used during the decoding process.

The decoded component color values will be substantially similar to the original component color values extracted in step 606. Once the decoded component color values are obtained using either Equation 3 or 4 (depending on the encoding algorithm used), step 626 of then reconstructs the pseudo-original digital color image using the new set of decoded component color values.

The advantages of the present embodiment are apparent when comparing process 600 with traditional compression techniques. In one instance, a 489-kilobyte Bitmap image file was compressed into JPEG format with a quality factor of 75. The resulting JPEG file size was 26.6 kilobytes. In comparison, using process 200 and by keeping the same quality factor, the present encoding process was able to compress the original Bitmap image down to 19.7 kilobytes, which is a further compression of 25% over traditional JPEG file. Moreover, process 600 was capable of further compressing the JPEG file by about 50% without losing image quality when reconstructed.

The present embodiment also achieves substantial improvement when compared with a commercially available software package such as WinZip. For example, for a Bitmap image with a file size of 2.89 megabytes, the zipped format only reduces the file size to 2.25 megabytes; in contrast, the present encoding algorithm was able to compress the file down to 1.19 megabytes, which is almost a 50% improvement over WinZip's capability in compressing a bitmap file. Furthermore, when the 1.19 megabytes file is reconstructed using the present process 600, there does not appear to have any discernible loss of image quality.

This application has been described in terms of exemplary embodiments. Other embodiments are within the scope of the following claims.

What is claimed is:

1. A method of compressing a digital image, the method comprising:
determining a composite color number for each pixel in a digital image represented by a plurality of pixels in a first color space;
extracting a first set of color values from the determined composite color numbers;
compacting the first set of color values into a second set of color values according to a predetermined encoding algorithm, wherein a quantity of color values in the second set of color values is smaller than a quantity of color values in the first set of color values;
generating a modified image based on the second set of color values; and
applying a transformation algorithm to the modified image.

2. The method of claim 1, wherein the transformation algorithm comprises:
translating the modified image into a second color space; and
converting the image in the second color space into a frequency space.

3. The method of claim 1, further comprising performing a Huffman compression coding on the transformed image.

4. The method of claim 1, wherein the predetermined encoding algorithm is
CV_{reduced}={[(CV_{original}*√2)*(CV_{original}/255)]+√(255*√2/√3)}/(2π); and
wherein CV_{reduced} represents the second set of color values and CV_{original} represents the first set of color values.

5. The method of claim 1, wherein the first set of color values are selected from a group of integers between 1 and 255.

6. The method of claim 1, wherein the second set of color values are selected from a group of integers between 1 and 255.

7. The method of claim 1, wherein the predetermined encoding algorithm is
CV_{reduced}=CV_{original}*k;
wherein k is a constant between about 0.01 to 1; and
wherein CV_{reduced} represents the second set of color values and CV_{original} represents the first set of color values.

8. The method of claim 1, wherein the digital image is one of a BMP format, JPEG format, TIFF format, and a GIF format.

9. The method of claim 1, wherein the first set of color values are derived from a standard color space.

10. The method of claim 9, wherein the standard color space is one of a (RGB) color space, a (CMY) color space, a (L*a*b) color space, a (YCC) color space, a (L*u*v) color space, a (Yxy) color space, a (HSV) color space, a (CMYK) color space, a (MCYK) color space, and a (RGBW) color space.

11. A method of transferring a compressed digital image, the method comprising:
determining a composite color number for each pixel in a digital image represented by a plurality of pixels in a first color space;
extracting a first set of color values from the determined composite color numbers;
compacting the first set of color values into a second set of color values according to a predetermined encoding algorithm, wherein a quantity of color values in the second set of color values is smaller than a quantity of color values in the first set of color values;
generating a modified image based on the second set of color values;
applying a transformation algorithm to the modified image;
transmitting the transformed image using a first communications device;
receiving the transformed image using a second communications device;
decoding the second set of color values into a third set of color values according to a predetermined decoding algorithm, wherein the third set of color values are substantially similar to the first set of color values; and
reconstructing the digital image using the third set of color values.

12. The method of claim 11, wherein the predetermined encoding algorithm is
CV_{reduced}={[(CV_{original}*√2)*(CV_{original}/255)]+√(255*√2/√3)}/(2π); and
wherein CV_{reduced} represents the second set of color values and CV_{original} represents the first set of color values.

13. The method of claim 11, wherein the predetermined encoding algorithm is
CV_{reduced}=CV_{original}*k;
wherein k is a constant between about 0.01 to 1; and
wherein CV_{reduced} represents the second set of color values and CV_{original} represents the first set of color values.

14. The method of claim 11, wherein the predetermined decoding algorithm is
CV_{decode}=CV_{reduced}*2π; and
wherein CV_{reduced} represents the second set of color values and CV_{original} represents the first set of color values.

15. The method of claim 11, wherein the predetermined decoding algorithm is
CV_{decode}=CV_{reduced}/k;
wherein k is a constant between about 0.01 to 1; and
wherein CV_{reduced} represents the second set of color values and CV_{original} represents the first set of color values.

16. The method of claim 11, wherein the transformation algorithm comprises:
translating the modified image into a second color space; and
converting the image in the second color space into a frequency space.

17. The method of claim 16, further comprising
performing a Huffman compression coding on the transformed image.

18. A method of enhancing a digital image, the method comprising:
determining a composite color number for each pixel in a digital image represented by a plurality of pixels in a first color space;
extracting a first set of color values from the determined composite color numbers;
compacting the first set of color values into a second set of color values according to a predetermined enhancement algorithm, wherein a quantity of color values in the second set of color values is smaller than a quantity of color values in the first set of color values; and
generating an enhanced image based on the second set of color values.

19. The method of claim 18, wherein the predetermined image enhancement algorithm is a quadratic relationship represented by:
CV_{enhanced}=(CV_{original}*CV_{original}/255); and
wherein CV_{enhanced} represents the second set of color values and CV_{original} represents the first set of color values.

20. The method of claim 18, wherein the predetermined image enhancement algorithm is a circular relationship represented by:
CV_{enhanced}=(CV_{original}*2π); and
wherein CV_{enhanced} represents the second set of color values and CV_{original} represents the first set of color values.

21. The method of claim 18, wherein the predetermined image enhancement algorithm results in a one-button contrast adjustment of the digital image.

22. The method of claim 18, wherein the predetermined image enhancement algorithm results in a one-button color adjustment of the digital image.

23. The method of claim 18, wherein the predetermined image enhancement algorithm results in a one-button light inversion of the digital image.

24. The method of claim 18, wherein the predetermined image enhancement algorithm results in a one-button brightness adjustment of the digital image.

25. The method of claim 18, wherein the predetermined image enhancement algorithm results in a one-button parametric adjustment of the digital image.
